(19) United States
(12) Patent Application Publication
(10) Pub. No.: US 2016/0366821 A1
(43) Pub. Date: Dec. 22, 2016

(54) CROP MAT MEASUREMENT THROUGH STEREO IMAGING

(71) Applicant: AGCO CORPORATION, Duluth, GA (US)

(72) Inventor: Grant GOOD, Moundridge, KS (US)

(21) Appl. No.: 14/650,838

(22) PCT Filed: Dec. 13, 2013
(86) PCT No.: PCT/US13/74964

§ 371 Date: Jun. 9, 2015

Related U.S. Application Data
(60) Provisional application No. 61/737,226, filed on Dec. 14, 2012.

(51) Int. Cl. A01D 41/127; G06K 9/00

(52) U.S. Cl. CPC A01D 41/1271; G06K 9/00657; H04N 5/247

(57) ABSTRACT

A method comprising receiving a scan or plural images of crop material located in an area between a cutting portion of a header and an input end of a conveyor of an agricultural machine, the header coupled to the agricultural machine; determining a crop material throughput based on the scan or the plural images; and adjusting a machine parameter of the agricultural machine based on the crop material throughput.

### CROSS REFERENCE TO RELATED APPLICATIONS

This application is a national phase application of international patent application number PCT/US2013/074964, filed Dec. 13, 2013, which claims priority to U.S. provisional application Ser. No. 61/737,226, filed Dec. 14, 2012. The full disclosures, in their entireties, of international patent application number PCT/US2013/074964 and U.S. provisional application No. 61/737,226 are hereby incorporated by reference.

### TECHNICAL FIELD

The present disclosure is generally related to agriculture technology, and, more particularly, computer-assisted farming.

### BACKGROUND

Recent efforts have been made to automate or semi-automate farming operations. Such efforts serve not only to reduce operating costs but also improve working conditions on operators and reduce operator error, enabling gains in operational efficiency and yield. For instance, combine harvesters may employ a form of cruise control, with the perceived benefits of preventing operator fatigue and maximizing machine efficiency.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an example combine harvester showing an embodiment of a detection system.

FIG. 2 is a schematic diagram showing a top perspective view of a feeder house and a header as viewed from the perspective of an imaging system mounted to the top of an operator cab of the combine harvester.

FIG. 3 is a schematic diagram showing a front elevation view of an input end of a feeder house where crop material in advance of the feeder house is imaged or scanned by an embodiment of an imaging system.

FIG. 4A is a block diagram showing an embodiment of a detection system.

FIG. 4B is a block diagram showing an embodiment of a controller for the detection system.

FIG. 5 is a flow diagram that illustrates an example embodiment of a detection method.

### DESCRIPTION OF EXAMPLE EMBODIMENTS

### Overview

In one embodiment, a method comprising receiving a scan or plural images of crop material located in an area between a cutting portion of a header and an input end of a conveyor of an agricultural machine, the header coupled to the agricultural machine; determining a crop material throughput based on the scan or the plural images; and adjusting a machine parameter of the agricultural machine based on the crop material throughput.

### DETAILED DESCRIPTION

Certain embodiments of detection systems and methods are disclosed that enable an agricultural machine to function in a form of cruise control, enabling a prediction of crop material processing load and adjustments to suitably handle the crop material once it enters the machine. In one embodiment, the detection system monitors a cross-sectional area of crop material (e.g., a crop mat, such as cut crops, cut weeds, and/or biomass) flowing into an agricultural machine, such as a combine harvester, as the crop material transitions from the header coupled to the combine harvester to a feeder house. The detection system correlates the cross-sectional area to a relative throughput (or as a measure of consistency of throughput) to enable and/or effect proper machine parameter adjustments, such as travel speed adjustments. In some embodiments, the detection system may facilitate the decision making of an operator as to proper machine parameter adjustments, providing a recommendation or indication of desirable or necessary adjustments (e.g., to prevent plugging or overloading of components of the agricultural machine).

In one embodiment, the detection system comprises an imaging system and a controller. The imaging system may comprise plural cameras or a laser scanner that capture plural images or a scan, respectively. The imaging system is mounted on the agricultural machine in a manner that enables the imaging (or scanning) of crop material located in the transition area between a cutting portion of the header and an input end of a conveyor of the agricultural machine, such as a conveyor of a feeder house. The controller, which may be embodied as a programmable logic controller (PLC), microcontroller, processor(s), or computer (or other computing device), receives the plural images or scan and determines a cross-sectional area of the imaged crop material. The controller then correlates the cross-sectional area to a relative throughput (or as a measure of consistency of throughput), and then determines suitable machine parameter adjustments to efficiently accommodate the throughput rate.

Digressing briefly, in conventional combine harvesters, for instance, the load on the feeder drive has been utilized to assist in making optimum or desired travel speed decisions. Often times, the load on the feeder drive can spike quickly if a large mat of crop material is fed in all at once from the header. In contrast, by monitoring the cross-sectional area of the crop mat as it transitions from the header into the feeder house, certain embodiments of a detection system enable an advanced warning to any abrupt changes so adjustments may be made to prevent plugging or overloading of the feeder. In some embodiments, the detection system may be used to determine the consistency with which the header is feeding crop material into the combine harvester, and may be used as an input to make header adjustments.

Note that one or more embodiments of detection systems comprise a plurality of cameras that are located in positions that enable image capture, from different perspectives, of the crop material as the crop material transitions from the header to the feeder house. The controller pairs these plural images to provide a stereoscopic image. In one embodiment, a point cloud comprising three dimensional coordinates of the imaged crop material is generated based on the stereoscopic image, and from the point cloud, a cross sectional area of the crop material is determined. In some embodiments, the generation of a point cloud may be omitted.

Having summarized certain features of detection systems of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, one focus is on an agricultural machine embodied as a combine harvester (hereinafter, referred to as a combine), though it should be appreciated that other self-propelled or towed agricultural machines that process crop material are contemplated to be within the scope of the disclosure. As another example, certain embodiments of detection systems are disclosed herein for illustration with a focus on stereoscopic imaging (e.g., plural cameras that capture an image from slightly different locations or perspectives to enable generation of a stereo image from the resulting image pairs and the generation of three dimensional coordinates). However, some embodiments may use other types of imaging systems, such as laser radar topography, among other types of imaging systems using other portions of the electromagnetic spectrum. Note that, although the emphasis herein is on the imaging of crop material as it transitions from the header to the feeder house, in some embodiments, the imaging system may further enable determination of one or more crop material parameters based on detection in front of the header (e.g., uncut crop material). Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the combine looking forwardly.

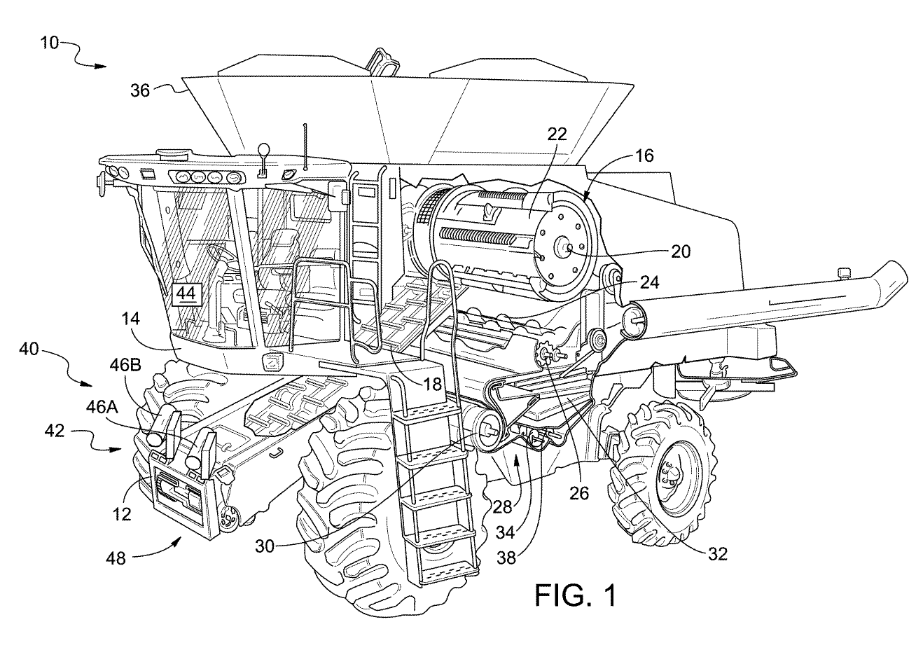

Referring now to FIG. 1, shown is an example agricultural machine embodied as a combine 10 in which an embodiment of a detection system may be implemented. It should be understood by one having ordinary skill in the art, in the context of the present disclosure, that the example combine 10 shown in FIG. 1 is merely illustrative, and that other combine configurations may be implemented in some embodiments. For instance, though shown as a single, transverse-rotor design, some embodiments of detection systems may be used in combines having an axial flow, hybrid, or dual rotor configuration, among other combine configurations, and hence are contemplated to be within the scope of the disclosure. The example combine 10 is shown in FIG. 1 without a header, and from front to back, comprises a feeder house 12 and an operator cab 14, followed by a processing compartment that includes a processing apparatus 16.

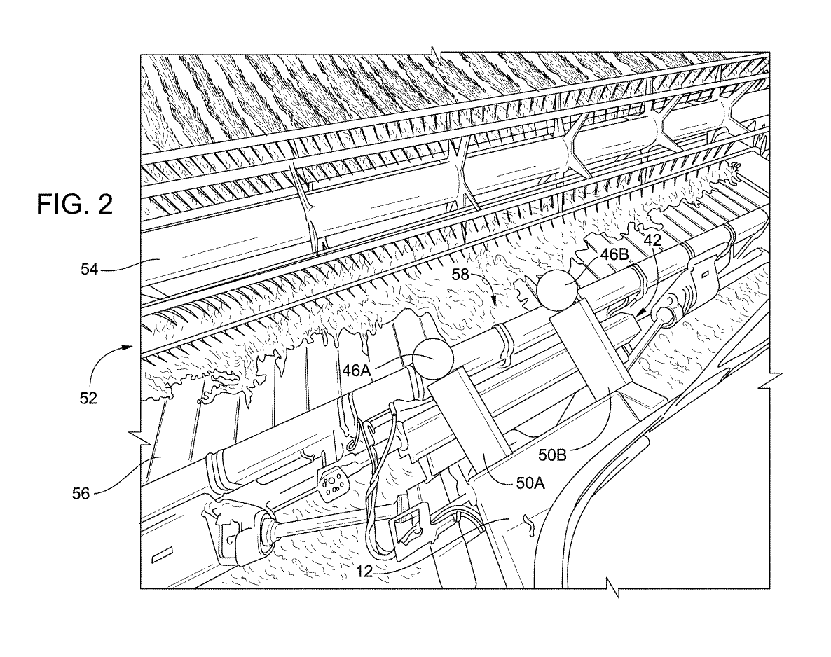

In operation, the combine 10 includes a harvesting header (shown in FIG. 2, as described later) at the front of the machine that cuts crop materials and delivers the cut crop materials to the front end of the feeder house 12. Such crop materials are moved upwardly and rearwardly within and beyond the feeder house 12 by a conveyer 18 until reaching a thresher rotor 20 of the processing apparatus 16. The thresher rotor 20 comprises a single, transverse rotor, such as that found in a Gleaner® Super Series Combine by AGCO. The thresher rotor 20 processes the crop materials in known manner and passes a portion of the crop material (e.g., heavier chaff, corn stalks, etc.) toward the rear of the combine 10 and another portion (e.g., grain and possibly light chaff) through a cleaning process, as described below. In some embodiments, such as in axial flow designs, the conveyor 18 may convey the cut crop material to a beater before reaching a rotor or rotors.

In the processing apparatus 16, the crop materials undergo threshing and separating operations. In other words, the crop materials are threshed and separated by the thresher rotor 20 operating in cooperation with certain elements of a cage 22, for instance, well-known foraminous processing members in the form of threshing concave assemblies and separator grate assemblies, with the grain (and possibly light chaff) escaping through the concave assemblies and the grate assemblies and onto one or more distribution augers 24 located beneath the processing apparatus 16. Bulkier stalk and leaf materials are generally retained by the concave assemblies and the grate assemblies and are disbursed out from the processing apparatus 16 and ultimately out of the rear of the combine 10. The distribution augers 24 uniformly spread the crop material that falls upon it, with the spread crop material conveyed to accelerator rolls 26. The accelerator rolls 26 speed the descent of the crop material toward a cleaning assembly 28. The cleaning assembly 28 includes a transverse fan 30 (or equivalently, a blower), which facilitates the cleaning of the heavier crop material directly beneath the accelerator rolls 26 while causing the chaff to be carried out of the rear of the combine 10. The cleaning assembly 28 also includes plural stacked sieves 32, through which the fan 30 provides an additional push or influence of the chaff flow to the rear of the combine 10. The cleaned grain that drops to the bottom of the cleaning assembly 28 is delivered by an auger 34 that transports the grain to a well-known elevator mechanism (not shown), which conveys the grain to a grain bin 36 located at the top of the combine 10. Any remaining chaff and partially threshed grain is recirculated through the processing apparatus 16 via a tailings return auger 38. As combine processing is known to those having ordinary skill in the art, further discussion of the same is omitted here for brevity.

The example combine 10 also comprises a detection system 40, which in one embodiment comprises an imaging system 42 (shown schematically) mounted on the combine 10, and a controller 44 (shown schematically). Though depicted in the operator cab 14, the controller 44 may be located elsewhere on the combine 10 in some embodiments. In the embodiment depicted in FIG. 1, the detection system 40 comprises the imaging system 42, which comprises plural (e.g., two) cameras 46A and 46B (collectively, cameras 46) mounted to the top of the feeder house 12, and a controller 44. It should be appreciated that the quantity and/or location of cameras 46 may vary in some embodiments. The imaging system 42 is generally mounted in a location within a range and view point that enables the capture of images (or scans in some embodiments, wherein a scanner may replace one of the cameras (e.g., the other camera omitted), and/or located in any of a plurality of places on the combine 10) of crop material located on the header proximal to the input end 48 of the feeder house 12. In some embodiments, the imaged area may expand along a greater width of the header (beyond a central portion proximal the inlet end 48). The cameras 46A, 46B are configured to operate in the visible light spectrum, and are depicted in this example as offset symmetrically across a longitudinal centerline of the feeder house 12, although it is not necessary for the cameras 46A and 46B to be symmetrically offset or offset with respect to the centerline. The cameras 46A, 46B are positioned to capture images of the crop material (e.g., cut crops or weeds or in general, biomass) located proximal to, and in front of, the feeder house 12. The captured image enables a determination of the cross-sectional area for a throughput (or consistency) determination by the controller 44. The captured image may also reveal one or more crop material parameters, such as a height of the crops along all or a portion of the width of the header, the density, and/or moisture content (e.g., via the color of the crop material).

The pair of images captured by the cameras 46A, 46B are used to produce stereo images and in some embodiments, a point cloud (or otherwise, three dimensional coordinates), as described below. Although described in the context of cameras operating in the visible spectrum, some embodiments of the imaging system 42 may operate in the non-visible spectrum, such as the infrared, ultraviolet, ultrasonic, among other ranges. In some embodiments, the imaging system 42 may be embodied as a laser radar topography system (referred to herein as a scanner or laser scanner).

FIG. 2 shows a top view showing the cameras 46A and 46B (schematically shown) mounted to a top surface of the feeder house 12. It should be appreciated within the context of the present disclosure that the imaging system arrangement depicted in FIG. 2 is for illustrative purposes, and that other arrangements with different securing locales and/or positional configurations of the cameras 46A and 46B may be used, and hence are contemplated to be within the scope of the disclosure. The feeder house 12 has coupled to its top surface the cameras 46A and 46B via camera mounts 50A and 50B (shown schematically). The camera mounts 50A and 50B (collectively, camera mounts 50) are secured to the feeder house top surface via bolts or screws or brackets, among other mechanisms well-known to those having ordinary skill in the art. In one embodiment, the cameras 46A and 46B are pivotally adjustable (e.g., enabling a swing from left to right and/or along the travel direction) via a pivotal mount to the camera mounts 50. In some embodiments, the cameras 46A and 46B may be secured to a rail or like structure that enables slidable or detachable movement along all or a portion of the width of the top surface of the feeder house 12. In some embodiments, the orientation of the cameras 46A and 46B are fixably secured to disallow tampering. In one embodiment, the cameras 46A and 46B are oriented to enable plural, offset images of a header 52 (and the crop material located on the header 52). As shown, the feeder house 12 has secured to it the header 52, shown partially in FIG. 2, which may be removed and replaced with other types of headers depending on the application. Although shown as a draper style header, certain embodiments of a detection system 40 (FIG. 1) may be used with other types of headers, such as pickup headers, corn headers, etc. In one embodiment, the header 52 comprises a cutting portion 54 for cutting the crops and a transition portion 56 that conveys (e.g., using a conveyor, such as a belt or belts, chain and slat configuration, etc.) the cut crops (e.g., crop material) toward a rear, center portion 58 of the header 52, as is known. The center portion 58 may comprise a feeder auger (not shown) to advance the harvested crop material onto the conveyor 18 (FIG. 1) of the feeder house 12, where the conveyor 18 conveys the crop material toward the processing apparatus 16.

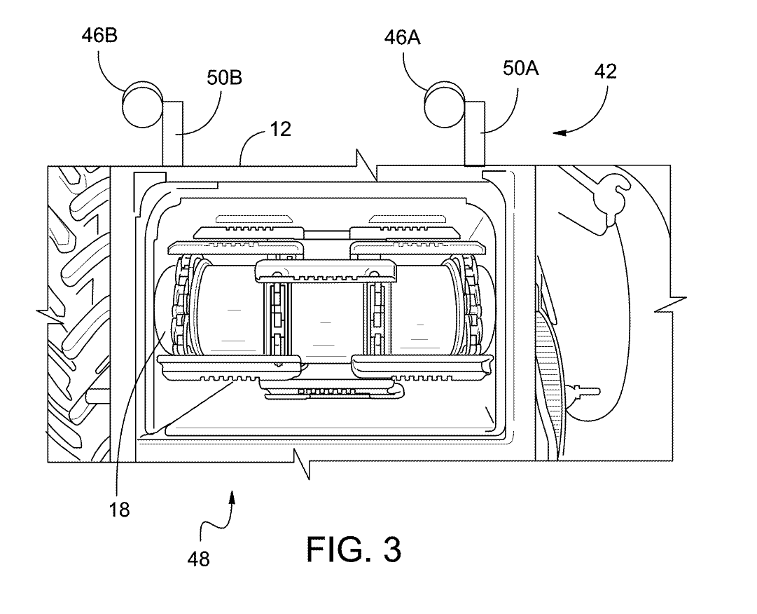

FIG. 3 shows an example feeder house 12 from a front elevation perspective, and in particular, from the input end 48. The feeder house 12 comprises the conveyor 18, shown in FIG. 3 as a chain and slat configuration, though other mechanisms for conveying the crop material received from the header 52 (FIG. 2) may be used in some embodiments, including belts, among other configurations. Also shown is the imaging system 42, including the cameras 46A and 46B secured to the camera mounts 50A and 50B, respectively, which are secured to the top surface of the feeder house 12.

In operation, and referring to FIGS. 2-3, the imaging system 42 captures plural images (or a scan) of the crop material located in and proximal to the center portion 58 of the header 52, where the crop material transitions from the header 52 to the conveyor 18 of the feeder house 12. As indicated above, the range of imaging (or scanning) may further include other portions of the transition portion 56, and in some embodiments, may include areas upstream of (e.g., in front of) the transition portion 56, such as in front of, and proximal to, the header 52. As indicated above, the detection system 40 (FIG. 1) enables a predictive determination of the load of the crop material that is to move through the combine 10 (FIG. 1) to prevent plugging or overloading of components in the combine 10, such as components in the feeder house 12, and to optimize and/or improve one or more machine parameters to handle the throughput rate of the crop material. In one embodiment, the plural images of a given area comprising crop material are captured by the cameras 46A and 46B (or scans are captured by a scanner), and the images or scan(s) may be communicated (e.g., over a wired connection or network, such as via a controller area network (CAN), or wirelessly) to the controller 44 (FIG. 1). The communication of images or scans may be implemented continuously, regularly (e.g., periodically, every defined quantity of feet of travel of the combine 10, every fixed time interval, etc.) or irregularly or aperiodically (e.g., responsive to a given event, such as operator intervention locally or remotely, or at random intervals).

The captured images or scan(s) are received at the controller 44 (FIG. 1), which pairs the images and in one embodiment determines a point cloud. The point cloud corresponds to a cross-sectional area of the imaged (or scanned) crop material. The controller 44 correlates the cross-sectional area to a crop throughput. For instance, the controller 44 may maintain a data structure, such as a look-up table, that correlates the cross-sectional area to the throughput (e.g., throughput rate). In some embodiments, the determination may be achieved algorithmically. The throughput determination may also be based on one or more additional data (e.g., sensed or inputted, such as by an operator), including combine speed, internal motor speeds, sensed moisture content, and/or environmental conditions (e.g., temperature, wind speed, etc.). Based on the images or scan, and in particular, the determined throughput (and/or in some embodiments, the cross-sectional area correlated to a consistency of throughput), the controller 44 determines an optimum or desirous machine parameter to accommodate the throughput rate. Machine parameters include ground speed of the combine 10, direction of the combine, internal machine parameters (e.g., fan speed, concave clearance, etc.), header placement (e.g., height, pitch, and/or yaw), and/or other header operations, such as speed of the cutting portion 54 or feeder auger proximal to the center portion 58. The controller 44 adjusts a setting(s) (e.g., voltage, current level, and/or digital value) corresponding to one or more of these machine parameters, and provides a corresponding control signal to an actuator (e.g., hydraulic valve, solenoid, cylinders, or other known actuating devices) to cause the adjustment in the machine parameter to take effect. For instance, the control signal from the controller 44 may be provided to a throttle and/or gear assembly to adjust the speed of the combine 10 (FIG. 1), or in some implementations to a hydraulic pump that adjusts the flow of fluid to one or more cylinders associated with a steering mechanism or header height adjustment for the combine 10, causing an adjustment in the direction of the combine 10 or the height of the header 52. Other machine parameters may be adjusted, as should be appreciated by one having ordinary skill in the art.

It should be appreciated within the context of the present disclosure that the manner of actuating the devices may vary depending on the application, where the control signal may be delivered to one or more devices upstream of the device directly responsible for the physical adjustment in the machine parameter, or directly to the actuating device directly responsible for effecting the adjustment in the setting.

In some embodiments, the imaging system 42 may be used to prompt additional actions and/or other actions (e.g., not directly involving the crop material throughput). In one embodiment, the imaging system 42 may detect an obstacle located on (or ahead of) the header 52. For instance, the one or more cameras 46A or 46B may capture an image of an obstacle, and the controller 44 (FIG. 1) may receive that image (or a stereo image) and determine (e.g., through well-known vision and/or feature detection algorithms) the presence of the obstacle and adjust one or more machine parameters to avert the obstacle (e.g., such as stopping the combine 10 (FIG. 1) or conveyor 18, etc.). In some embodiments, the controller 44 may alert an operator in the operator cab 14 or elsewhere (e.g., remotely) of the obstacle or even of the adjustments before (e.g., seeking approval, or making a recommendation), during, or after they are implemented. Such alerts may be in the form of an audible, visible, and/or tactile alert on or associated with user interface equipment (e.g., displays, headsets, joysticks, etc.) in the operator cab 14 (FIG. 1).

As indicated above, in some embodiments, the controller 44 (FIG. 1) may adjust one or more machine parameters autonomously, such as in an automated or semi-automated agricultural system. In some embodiments, the controller 44 may adjust the one or more machine parameters with some operator involvement, such as to provide an alert or notification of the adjustment or an impending adjustment (e.g., allowing the operator to allow or disallow or override the adjustment). In some embodiments, the controller 44 may merely cause a visual or audible (e.g., verbal or via a sound, such as a buzzer) notification that involves a recommendation (e.g., shown on a graphical user interface on a console in the operator cab 14 (FIG. 1)) as to the appropriate adjustment that the operator should make in view of an assessment by the controller 44 of the image(s) or scan.

The controller 44 (FIG. 1) may include a computer or microcontroller or other computing device embodied in a single package (e.g., enclosure) or with the same or similar functionality distributed among several components. The controller 44, as explained below, may receive the plural images and pair the images to provide a stereoscopic image. As is known, the stereoscopic image may be decomposed into, or otherwise represented by, a point cloud, which the controller 44 uses to determine the throughput (e.g., throughput rate). In some embodiments, one or more of the functionality of the controller 44 may be implemented in the cameras 46A and 46B or scanner. In some embodiments, the plural images (or scan) are communicated by one or more of the cameras 46A and 46B to the controller 44, which then generates the point cloud and determines the crop throughput. The controller 44 may cause the display of the throughput rate on a computer monitor or other display device (or in some embodiments, store to memory or generally a computer readable medium) located proximally to, or remotely from, the detection system 40. The controller 44 may coordinate with other components or sub-systems of the combine 10 (FIG. 1) as part of the processing of imaged or scanned information, such as coordinates provided by a global positioning system (GPS) or other positioning systems or mechanisms.

In some embodiments, the images (e.g., or scan(s)), the stereoscopic images, the point cloud, cross-sectional area, and/or throughput, may be communicated to a remote processing system (e.g., computer) located remotely from the combine 10 (FIG. 1, such as in a farm management office, farmer's home, or elsewhere), where all or a portion of the functionality of the controller 44 (FIG. 1) may be performed at a remote location, such as on a computer. Such communication may be performed over a wireless network and/or combination of wired (e.g., landline phone or cable system) and wireless (e.g., from a transceiver in the combine 10 (FIG. 1)). For instance, the combine 10 may be operated and/or at least controlled in part from a remote location, based on the communicated feedback from the detection system 40.

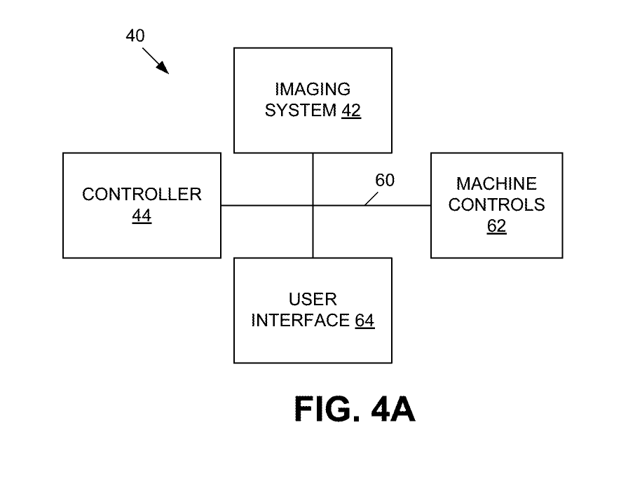

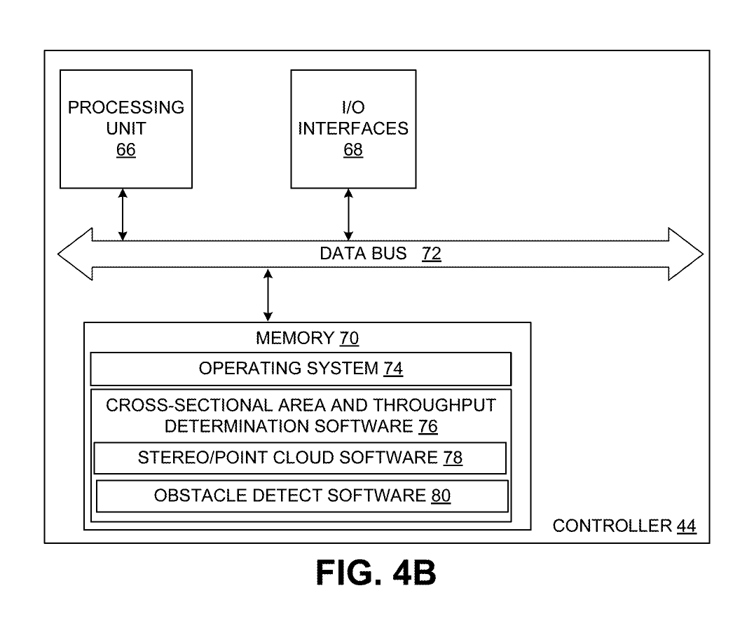

Attention is now directed to FIG. 4A, which illustrates an embodiment of a detection system 40. It should be appreciated within the context of the present disclosure that some embodiments may include additional components or fewer or different components, and that the example depicted in FIG. 4A is merely illustrative of one embodiment among others. The detection system 40 comprises the controller 44 coupled in a CAN network 60 (though not limited to a CAN network or a single network) to the imaging system 42, machine controls 62, and a user interface 64. The imaging system 42 has been described already, and may include visible and non-visible spectrum devices, such as cameras, laser radar technology, etc. The machine controls 62 collectively comprise the various actuators, sensors, and/or controlled devices residing on the combine 10 (FIG. 1), including those used to control machine navigation (e.g., speed, direction, etc.), header position and/or control, feeder house operation, among others. The user interface 64 may be a keyboard, mouse, microphone, touch-type display device, or other devices (e.g., switches) that enable input by an operator (e.g., such as while in the operator cab 14 (FIG. 1)).

The controller 44 receives and processes the information from the imaging system 42 and delivers control signals to the machine controls 62 (e.g., directly, or indirectly through an intermediary device in some embodiments). In some embodiments, the controller 44 may receive input from the machine controls 62 (e.g., such as to enable feedback as to the position or status of certain devices, such as header height, speed of the combine 10, internal processing, etc.), and/or receive input from other devices, such as global positioning devices, transceivers, etc. The controller 44 may also receive input from the user interface 64, such as during the process of adjustment to provide feedback of a change in throughput and/or machine parameters, or an impending change or need or recommendation for change.

FIG. 4B further illustrates an example embodiment of the controller 44. One having ordinary skill in the art should appreciate in the context of the present disclosure that the example controller 44 is merely illustrative, and that some embodiments of controllers may comprise fewer or additional components, and/or some of the functionality associated with the various components depicted in FIG. 4B may be combined, or further distributed among additional modules, in some embodiments. Referring to FIG. 4B, with continued reference to FIG. 4A, the controller 44 is depicted in this example as a computer system, but may be embodied as a programmable logic controller (PLC), FPGA, among other devices. It should be appreciated that certain well-known components of computer systems are omitted here to avoid obfuscating relevant features of the controller 44. In one embodiment, the controller 44 comprises one or more processing units, such as processing unit 66, input/output (I/O) interface(s) 68, and memory 70, all coupled to one or more data busses, such as data bus 72. The memory 70 may include any one or a combination of volatile memory elements (e.g., random-access memory RAM, such as DRAM, and SRAM, etc.) and nonvolatile memory elements (e.g., ROM, hard drive, tape, CDROM, etc.). The memory 70 may store a native operating system, one or more native applications, emulation systems, or emulated applications for any of a variety of operating systems and/or emulated hardware platforms, emulated operating systems, etc. In some embodiments, the memory 70 may store one or more data structures, such as a look-up table to facilitate the correlation of throughput from the cross-sectional area. In the embodiment depicted in FIG. 4B, the memory 70 comprises an operating system 74, and cross-sectional area and throughput determination software 76 that in one embodiment comprises stereo/point cloud software 78 and obstacle detection software 80. It should be appreciated that in some embodiments, additional or fewer software modules (e.g., combined functionality) may be employed in the memory 70 or additional memory. In some embodiments, a separate storage device may be coupled to the data bus 72, such as a persistent memory (e.g., optical, magnetic, and/or semiconductor memory and associated drives).

The cross-sectional area and throughput determination software 76 correlates the cross-sectional area of the imaged or scanned crop material to a throughput rate and/or a measure of consistency of throughput based on the plural images or scan received from the imaging system 42. The cross-sectional area and throughput determination software 76 may determine relative throughputs (e.g., based on a threshold change in throughput) and/or absolute throughputs (e.g., for each cross-sectional area determination, there is a benchmark comparison to associate the cross-sectional area (alone or based on additional data) to known or calibrated throughput rates. The stereo/point cloud software 78 enables the pairing of plural images and generation of three-dimensional coordinates of the paired images or scan, enabling the determination of the one or more crop material parameters. The obstacle detect software 80 enables the detection of obstacles according to well-known vision and/or feature recognition software.

Execution of the software modules 74-80 is implemented by the processing unit 66 under the management and/or control of the operating system 74. In some embodiments, the operating system 74 may be omitted and a more rudimentary manner of control implemented. The processing unit 66 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the controller 44.

The I/O interfaces 68 provide one or more interfaces to the network 60 and other networks. In other words, the I/O interfaces 68 may comprise any number of interfaces for the input and output of signals (e.g., analog or digital data) for conveyance over the network 60. The input may comprise input by an operator (local or remote) through the user interface 64 (e.g., a keyboard or mouse or other input device (or audible input in some embodiments)), and input from signals carrying information from one or more of the components of the detection system 40, such as machine controls 62 among other devices.

When certain embodiments of the controller 44 are implemented at least in part as software (including firmware), as depicted in FIG. 4B, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the controller 44 are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

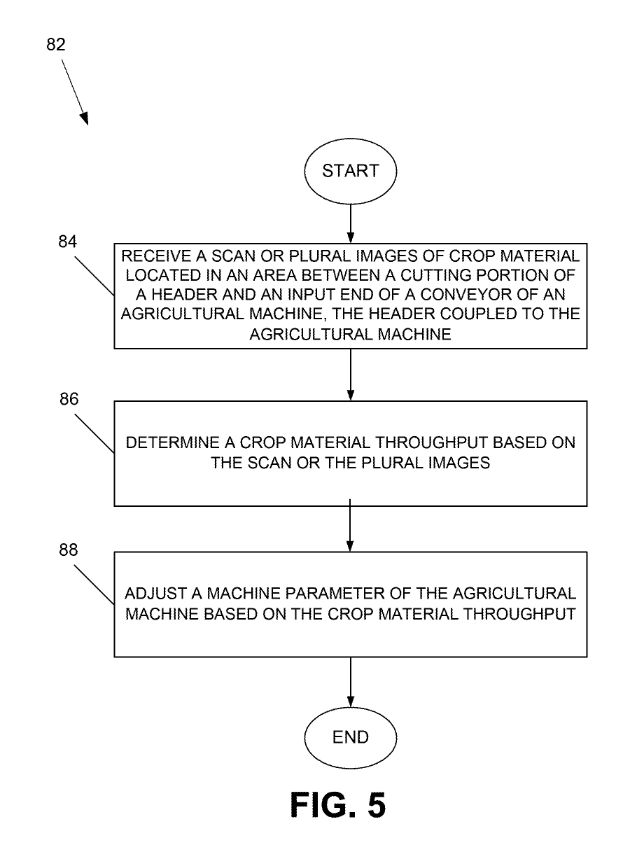

Having described certain embodiments of a detection system 40, it should be appreciated within the context of the present disclosure that one embodiment of a detection method, denoted as method 82 as illustrated in FIG. 5, comprises receiving a scan or plural images of crop material located in an area between a cutting portion of a header and an input end of a conveyor of an agricultural machine, the header coupled to the agricultural machine (84). As described above, the conveyor 18 (FIG. 1) may be a part of a feeder house 12 (FIG. 1), or as part of other components or sub-systems depending on the agricultural machine used. The method 82 further comprises determining a crop material throughput based on the scan or the plural images (86) and adjusting a machine parameter of the agricultural machine based on the crop material throughput (88).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A method, comprising:
receiving a scan or plural images of crop material located in an area between a cutting portion of a header and an input end of a conveyor of an agricultural machine, the header coupled to the agricultural machine;
determining a crop material throughput based on the scan or the plural images; and
adjusting a machine parameter of the agricultural machine based on the crop material throughput.

2. The method of claim 1, further comprising capturing the scan of the crop material from a scanner mounted on the agricultural machine.

3. The method of claim 1, further comprising capturing the plural images of the crop material from a plurality of cameras mounted on the agricultural machine.

4. The method of claim 1, wherein determining the crop material throughput comprises determining a cross-sectional area of the crop material and correlating the cross-sectional area to the crop material throughput.

5. The method of claim 1, wherein adjusting the machine parameter or machine parameters comprises adjusting internal machine parameters, a speed or direction, or a combination of internal machine parameters, speed, and direction, of the agricultural machine.

6. The method of claim 1, wherein adjusting the machine parameter comprises adjusting header operations.

7. The method of claim 1, further comprising determining a measure of consistency that the header feeds the crop material to the conveyor.

8. The method of claim 7, further comprising adjusting the machine parameter based on the measured consistency.

9. The method of claim 1, further comprising providing a notification of the crop material throughput to an operator.

10. The method of claim 9, wherein adjusting the machine parameter of the agricultural machine is based on intervention by the operator.

11. The method of claim 1, further comprising adjusting the crop material throughput based on the adjusted machine parameter.

12. An agricultural machine, comprising:
a conveyor having an input end;
a header coupled to the agricultural machine, the header comprising a cutting portion; and
a detection system comprising:
a controller; and
an imaging system mounted to the agricultural machine, wherein the controller is configured to receive, from the imaging system, plural images or a scan of crop material located in an area between the cutting portion and the input end of the conveyor and adjust a machine parameter of the agricultural machine based on the plural images or the scan.

13. The agricultural machine of claim 12, wherein the imaging system comprises a plurality of cameras that are configured to capture the plural images of the crop material.

14. The agricultural machine of claim 12, wherein the imaging system comprises a scanner that is configured to capture the scan of the crop material.

15. The agricultural machine of claim 12, wherein the controller is configured to determine a crop material throughput by determining a cross-sectional area of the crop material and correlating the cross-sectional area to the crop material throughput.

16. The agricultural machine of claim 12, wherein the controller is configured to adjust the machine parameter or machine parameters by adjusting one or more settings corresponding to machine navigation, machine internal processing, or a combination of machine navigation and machine internal processing of the agricultural machine.

17. The agricultural machine of claim 12, wherein the controller is configured to adjust the machine parameter by adjusting header settings corresponding to header operations.

18. The agricultural machine of claim 12, wherein the controller is further configured to determine a measure of consistency that the header feeds the crop material to the conveyor and adjust the machine parameter based on the measured consistency.

19. The agricultural machine of claim 12, wherein the controller is further configured to adjust the crop material throughput based on the adjusted machine parameter.
